(19) United States
(12) Patent Application Publication
(10) Pub. No.: US 2008/0254181 A1
(43) Pub. Date: Oct. 16, 2008

(54) Anti-Foaming Device

(76) Inventor: Rex Allan Mason, Auckland (NZ)

Correspondence Address: KNOBBE MARTENS OLSON & BEAR LLP, 2040 MAIN STREET, FOURTEENTH FLOOR, IRVINE, CA, 92614, US

(21) Appl. No.: 10/576,705

(22) PCT Filed: Oct. 15, 2004
(86) PCT No.: PCT/NZ04/00259

§ 371 Date: Feb. 22, 2008

(30) Foreign Application Priority Data
Oct. 21, 2003 (NZ) 529066

(51) Int. Cl. A01J 11/02; A01J 11/04; B01D 19/02

(52) U.S. Cl. 426/487; 210/180; 210/742

(57) ABSTRACT

An anti-foaming device (1) configured to reduce foaming of a fluid within a fluid reservoir (2, 3), the device including; a conduit (5) wherein the conduit (5) is in contact with at least a part of the exterior surface of the fluid reservoir (2, 3); a thermally conductive media wherein the media is past through the conduit (5); and, a heat transfer device; characterised in that the heat transfer device controls the temperature of the media within the conduit to hold the temperature of the fluid above or below a foaming temperature.

### TECHNICAL FIELD

This invention relates to an anti-foaming device.

In particular, this invention relates to an anti-foaming device for the use in animal husbandry where the milking of an animal and the subsequent storage of that milk is required.

Reference throughout the specification shall now be made to use of the present invention in relation to the control of foaming in milk.

However, this should not be seen to be a limitation on the present invention in any way as it may be used with any other fluid where foaming can occur under certain temperature and pressure conditions.

### BACKGROUND ART

The use of fluid treatment systems within the dairy industry is well known, particularly for the collection and storing of milk from a herd of animals.

Historically milk was manually extracted from animals. Milk was generally collected into a pail before being transferred to some form of holding tank prior to its disposal.

The advent of electro-mechanical milking equipment not only greatly improved the sanitation of the old system, it also improved the yield considerably.

Another improvement with the electro-mechanical system is that the operator could milk more than one animal at a time.

The milk extracted from the animals was done so under a “system vacuum” (this reduced the gas pressure within the milkline connected to the teat in order to extract the milk from the teat).

Due to the nature of both manual and electro-mechanical extracton of milk from an animal a volume of gas becomes entrained within the milk prior to the milk entering a bulk storage tank.

Although the electro-mechanical milking systems overcome most of the problems associated with the previous manual milking method they do not overcome the problems associated with the introduction of entrained gas into the product.

An extremely significant problem caused by the introduction of gas is that under certain seasonal temperature conditions foaming of the milk will be more prevalent.

Another drawback of the presence of entrained gas is that a greater volume is needed to store the product as the gas increases the overall volume of the product.

This also introduces a further drawback for the farmer in that when tested the milk indicates that it has a lower milk solids content per litre due to the presence of the entrained gas.

A further drawback with the introduction of gas into the product is that it can encourage the proliferation of aerobic bacteria developing within the milk.

The improved fluid treatment system disclosed in New Zealand Patent Application No. 528893 overcomes all the aforementioned problems apart from the foaming of the milk under certain seasonal temperature conditions.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect of the present invention there is provided an anti-foaming device, configured to reducing foaming of a fluid within a fluid reservoir, the device including,

a conduit, wherein the conduit is in contact with at least a part of the exterior surface of the fluid reservoir, and
a thermally conductive media, wherein the media is passed through the conduit, and
a heat transfer device,
characterised in that,
the heat transfer device controls the temperature of the media within the conduit to hold the temperature of the fluid above or below a foaming temperature.

Throughout the present specification the fluid should now be referred to as being milk however this should not be seen to be a limitation on the present invention as it is equally feasible for the present invention to be used with any other fluid that is prevalent to foaming under certain temperature and pressure conditions.

Throughout the present specification the media shall now be referred to as being water in the form of an ice slurry however this also should not be seen to be a limitation on the present invention as the media can be any flowable material, or combination of materials, capable of altering the temperature of the fluid within the fluid reservoir to a position outside the range at which it can foam.

For example, in some embodiments the media could be pure liquid water, refrigerant gas or glycol.

In preferred embodiments of the present invention the water is pumped through the conduit to ensure an adequate flowrate of the water is achieved for an adequate level of heat transfer to occur between the water and the milk.

It should be appreciated that while it is envisaged that in most embodiments of the present invention the fluid will be cooled, it is possible that in other embodiments the fluid could be heated so that it is taken above the temperature at which foam would normally occur. Thus, the reference to cooling should not be seen as limiting.

However, it should be appreciated that in the dairy industry it is usually desirable to cool milk as quickly as possible for a number of reasons including improving the microbiological quality of the milk and possible reduction in fat damage caused by pumping.

It should be appreciated that the present invention not only provides a mean to prevent foaming in a fluid, but it also provides an effective method by which fluid, and in particular milk can be chilled rapidly. These dual benefits of the present invention are very desirable for the dairy industry.

It should also be appreciated that in preferred embodiments of the present invention the conduit is constructed as a spiral jacket. The spiral jacket is preferably fitted around the external surface of the fluid reservoir. Most likely the spiral jacket is held within an external skin. Preferably the construction and the fitting of the jacket and the fitting of it in relation to the fluid reservoir ensures there is adequate water flow throughout the conduit sufficient to eliminate any dead-spots where the water flow rate is insufficient to adequately control the temperature of the milk.

In some embodiments of the present invention the external surface of the fluid reservoir may be textured. This can present a greater surface area which is exposed to the cooling jacket as a consequence. This enables greater amount of heat transfer between the fluid held within the reservoir and the jacket.

This should not however be seen to be a limitation on the present invention in any way as in other embodiments the conduit can be formed in other configurations than as a spiral and may even be constructed simply as an outer skin wherein the water flows between the outer skin and the fluid reservoir wall.

In preferred embodiments of the present invention the fluid reservoir should be understood to be at least part of the invention disclosed in New Zealand Patent Application No. 528893 and in particular the secondary chamber thereof.

This should not however be seen to be a limitation on the present invention in any way as in other embodiments the fluid reservoir can be other means for holding a volume of fluid, an example of which would be a standard milk reservoir, for example a receiving can.

The foaming of milk only occurs over a relatively small temperature range for any given pressure, therefore if the pressure at which the milk is held is known then the calculation at which temperature the milk is likely to foam would be quite straightforward.

In conventional milking systems foaming of the milk can occur in milk lines as well as in the milk reservoir at certain times of the year.

This is due to seasonal temperature variations causing the temperature of the milk to reach the point at which foaming occurs.

This drawback is equally true for the device disclosed in New Zealand Patent Application No. 528893 although it should be noted that due to the thin film of milk on the surface of the secondary chamber the heat transfer of the milk will be far faster and more efficient due to the increased contact area for heat transfer.

Thus, the present invention particularly when combined with the device described above provides a rapid chilling/cooling device with a synergistic effect occurring through the use of the jacket and the increased surface area/low pressure provided by the fluid reservoir.

It should also be noted that use of the present invention increases removal of entrained gas from within the milk as well as removing most of the natural vapours from within the milk and thereby further improving the organoleptics of the milk.

Another advantage of the present invention is that the water exiting the present invention can be used for other applications (such as teat washing) as in most applications cooling of the milk will be required and therefore the exit water will have an increased temperature.

The exit water from the present invention can be used for other applications, examples of which would be cleaning down the equipment or the milking area.

From the aforegoing it is clear that the present invention has a significant advantage over all the conventional milking systems available and can provide the farmer and hence the consumer with a consistent and sweet smelling product throughout the year and which is unaffected by any seasonal temperature variations.

### BRIEF DESCRIPTION OF DRAWINGS

Further aspects of the present invention will become apparent from the following description which is given by way of example only and with reference to the accompanying drawings in which:

FIG. 1 is a diagrammatical representation of a sectional view of the present invention cut through its vertical mid-line.

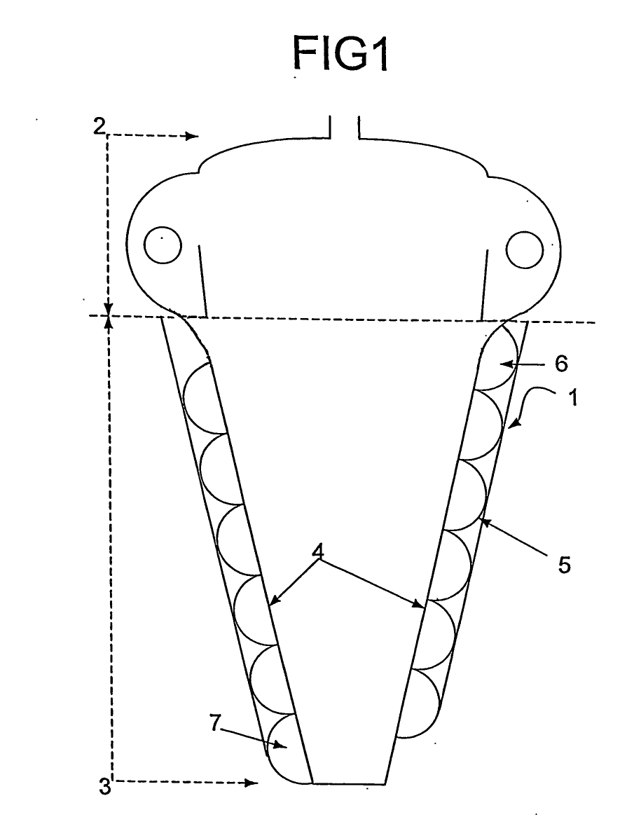

### BEST MODES FOR CARRYING OUT THE INVENTION

With reference to the FIGURE there is illustrated an anti-foaming device generally indicated by arrow 1.

The anti-foaming device (1) is shown fitted to the improved fluid treatment system (disclosed in New Zealand Patent Application No. 528893).

It should be appreciated that this configuration is the most efficient shape for the present invention as with the secondary chamber (3) having a vertically conical side wall (4), a thin film laminar flow is formed on at least part of its surface—which ensures a heat transfer between the milk contained within the secondary chamber (3) and the water flowing within the present invention (1) can take place quickly and effectively.

The anti-foaming device (1) is formed as a set of coils (5) fitted to the outside of the secondary chamber (3) of the improved fluid treatment system (2,3) in order that water pumped through the coils (5) achieves a good level of heat transfer, through the wall (4) of the secondary chamber (3), with the milk.

The coils are actually fitted within an external skin. This means that the outside of the anti-foaming device in preferred embodiments is substantially planer.

Water enters the anti-foaming device (1) at the water inlet (7) and circulates around the coils (5) until it leaves the coils at the water outlet (6).

The water can then be reused throughout the farm as required, or may be, treated and recycled within the process or may simply be disposed of.

Aspects of the present invention have been described by way of example only and it should be appreciated that modifications and additions may be made thereto without departing from the scope of the appended claims.

1. An anti-foaming device configured to fit a fluid treatment system, and configured to reduce foaming of a fluid within the fluid treatment system, the device including,
a conduit wherein the conduit is in contact with at least a part of the exterior surface of the fluid treatment system,
a thermally conductive media wherein the media is passed through the conduit, and
a heat transfer device,
wherein the heat transfer device is configured to control the temperature of the media within the conduit to hold the temperature of the fluid within the fluid treatment system above or below a foaming temperature.

2. An anti-foaming device as claimed in claim 1 wherein the fluid to be treated is milk.

3. An anti-foaming device as claimed in claim 1 wherein the media is water.

4. An anti-foaming device as claimed in claim 1 wherein the conduit is configured in the form of a spiral jacket.

5. An anti-foaming device as claimed in claim 4 wherein the spiral jacket is fitted around the external surface of the fluid treatment system.

6. An anti-foaming device as claimed claim 1 wherein the conduit is fitted to ensure that adequate media flow throughout the conduit is sufficient to eliminate any dead spots where the media flow rate is insufficient to adequately control the temperature of the fluid.

7. A method of reducing foaming of a fluid within a fluid treatment system by operating an anti-foaming device which includes
a conduit wherein the conduit is in contact with at least a part of the exterior surface of the fluid treatment system,
a thermally conductive media wherein the media is passed through the conduit, and
a heat transfer device,
said method comprising the steps of:
a). introducing a fluid to the fluid treatment system, and
b). controlling the temperature of the media within the conduit with the heat transfer device to hold the temperature of the fluid above or below a foaming temperature.

8. A method as claimed in claim 7 wherein the fluid is milk.

9. A method as claimed in claim 7 wherein the media is water.

10. A method as claimed in claim 7 wherein the conduit is configured in the form of a spiral jacket.

11. A method as claimed in claim 10 wherein the spiral jacket is fitted around the external surface of the fluid treatment system.

12. A method as claimed in claim 7 wherein the conduit is fitted to ensure that adequate media flow throughout the conduit is sufficient to eliminate any dead spots where the media flow rate is insufficient to adequately control the temperature of the fluid.

13. A method of chilling a fluid by operating an anti-foaming device as claimed in claim 1
said method comprising the steps of:
a). introducing a fluid to the fluid treatment system and
b). controlling the temperature of the media within the conduit with the heat transfer device to hold the temperature of the fluid above or below a foaming temperature.

14.-16. (canceled)
